(19) United States
(12) Patent Application Publication
(10) Pub. No.: US 2021/0024731 A1
(43) Pub. Date: Jan. 28, 2021

(54) CELLULOSE FIBER POLYMER COMPOSITES WITH HIGH FIBER DISPERSION AND RELATED METHODS OF MAKING

(71) Applicant: International Paper Company, Memphis, TN (US)

(72) Inventors: Abaneshwar Prasad, Des Moines, WA (US); James Lochary, Reistertown, MD (US); Arash Kiani, Upper Saddle River, NJ (US)

(73) Assignee: International Paper Company, Memphis, TN (US)

(21) Appl. No.: 16/520,154

(22) Filed: Jul. 23, 2019

(51) Int. Cl. C08L 23/12; B29B 7/92; B29B 9/14; C08J 3/22

(52) U.S. Cl. CPC C08L 23/12; B29B 7/92; B29K 2201/00; C08J 3/226; B29B 9/14

(57) ABSTRACT

Cellulose fiber polymer composites having low cellulose fiber agglomerate counts and related method of making cellulose fiber polymer composites are described. In an embodiment, the cellulose fiber polymer composites have a cellulose fiber agglomerate count of a 4 g pellet press-out of less than about 25. In an embodiment, the cellulose fiber polymer composites have a Yellowness index of less than about 32, such as for composite pellets made from virgin PP and recycled white PP.

### BACKGROUND

Cellulose Fiber (CF)-based polymer composites are used in variety of applications. CFs dispersed in a polymer offer some advantages over traditional inorganic fillers, such as glass fibers, talc, mica, and the like. The CFs generally have lower density; are recyclable; are made from renewable resources; and polymer composites made with CFs have higher strength, stiffness, and cycle time reduction compared to unfilled resin and polymers impregnated with conventional inorganic fillers. Such characteristics make CF-based composites an attractive material.

However, dispersing CF in a matrix of non-polar thermoplastics, such as polyolefins, can present many challenges. CFs are generally rich in hydroxyl groups, making them polar. Due to strong inter- and intra-molecular bonding of the hydroxyl groups, it is often difficult to achieve substantially homogeneous dispersion of CF in non-polar thermoplastic matrices, especially when non-debonded pulp sheet is used as a source of CF. Achieving good, excellent or perfect dispersion of CFs into a polymer, especially hydrophobic polymer, is particularly difficult at higher output rates. Even with hydrophilic polymers, good dispersion is not easy to achieve as the CF-fiber bonding can be stronger than the cellulose-hydrophilic polymer interaction.

### SUMMARY

Toward that end, in an aspect, the present disclosure provides a method of forming a cellulose fiber (CF) polymer composite. In an embodiment, the method includes introducing a master batch (MB) into a twin-screw extruder, the MB comprising a polymeric matrix and CFs coated with the polymeric matrix; and mixing the MB in the twin-screw extruder to form the CF polymer composite. In an embodiment, a CF agglomerate count of a 4 g pellet press-out of the CF polymer composite produced by the method of the present disclosure is less than about 25.

In another aspect, the present disclosure provides a CF polymer composite. In an embodiment, the CF polymer composite includes a polymeric matrix; and CFs distributed within the polymeric matrix. In an embodiment, a CF agglomerate count of a 4 g pellet press-out of the CF polymer composite is less than about 25.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 includes press-out images of a conventional cellulose fiber (CF) polymer composite (PROPELTM, black colored pellets commercially available from West Fraser Mills LTD., Product code 8010-001 BLK), where CF agglomerates are seen as white spots, where a CF agglomerate a count is greater 100;

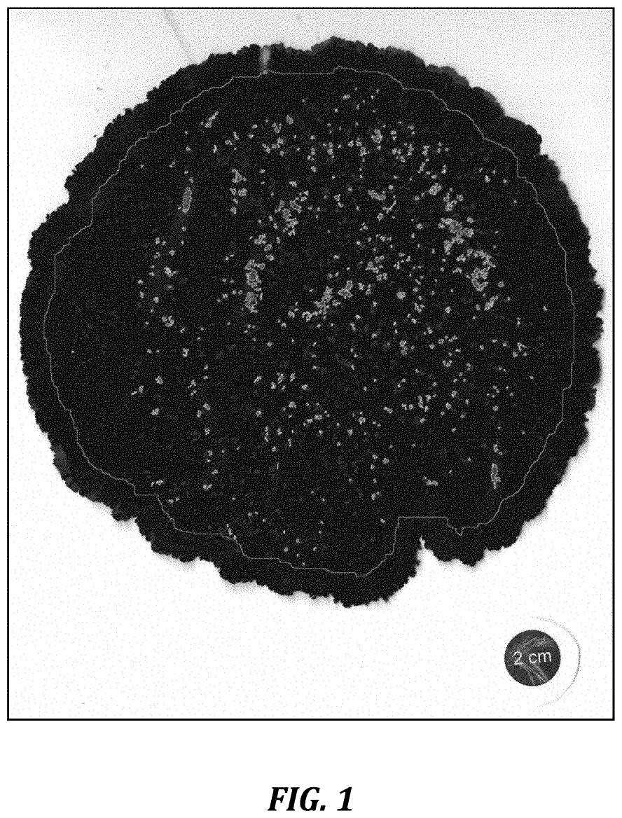

FIG. 2 includes press-out images of another conventional CF polymer composite (Sample 1), where a CF agglomerate count is 26;

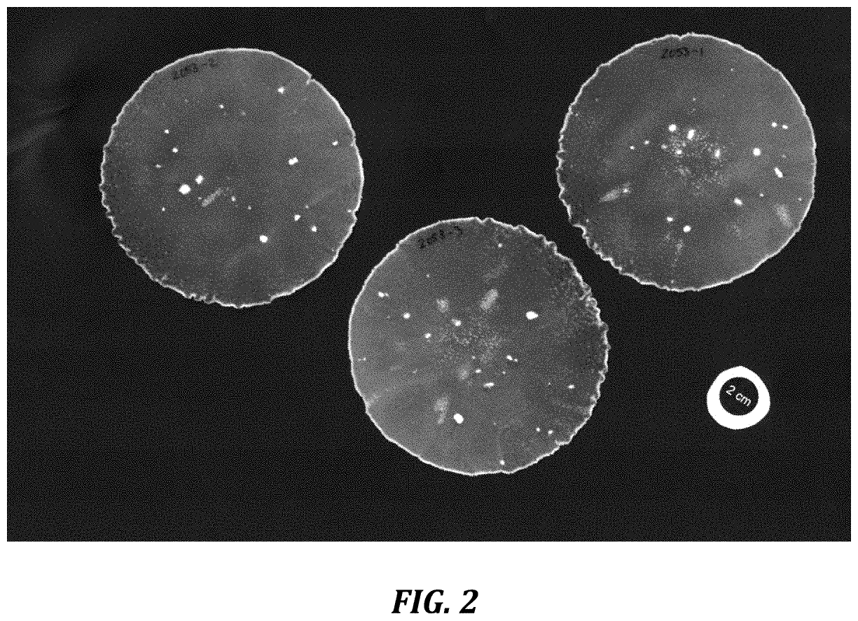

FIG. 3 includes press-out images of a CF polymer composite (Sample 2), in accordance with an embodiment of the disclosure, where a CF agglomerate count is 6;

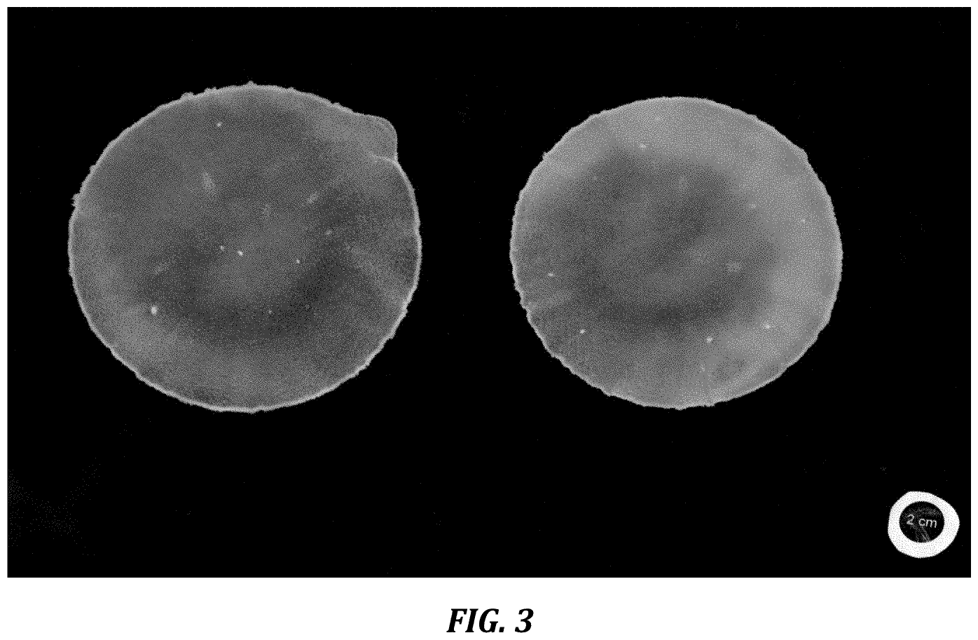

FIG. 4 includes press-out images of another CF polymer composite (Sample 3), in accordance with an embodiment of the disclosure, where a CF agglomerate count is 13;

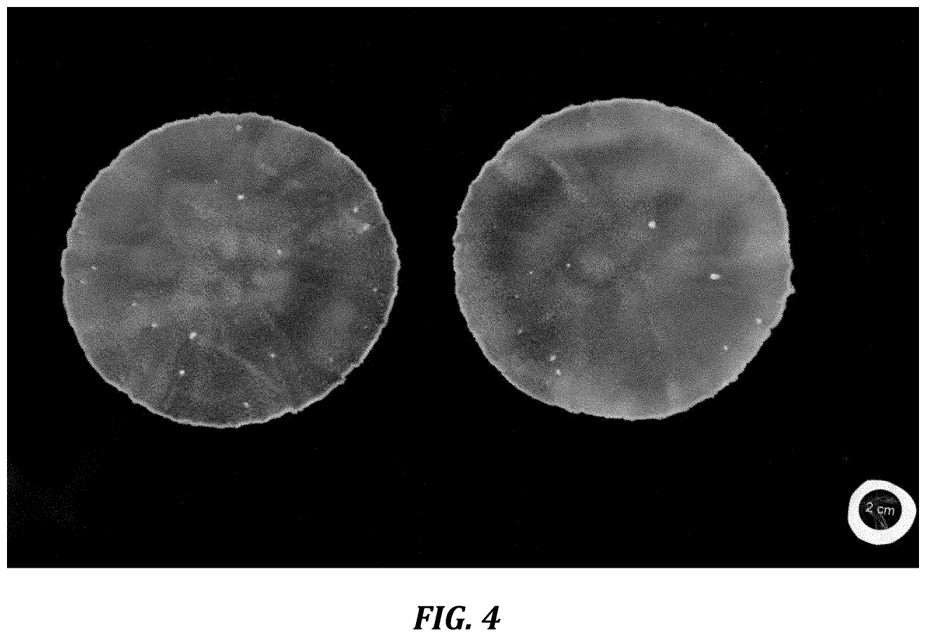

FIGS. 5A and 5B are press-out images of another CF polymer composite (Sample 4), in accordance with an embodiment of the disclosure, where a CF agglomerate count is 15;

FIG. 6 is a graphical illustration of melt flow index (MFI) vs applied load of CF polymer composites, in accordance with an embodiment of the disclosure; and

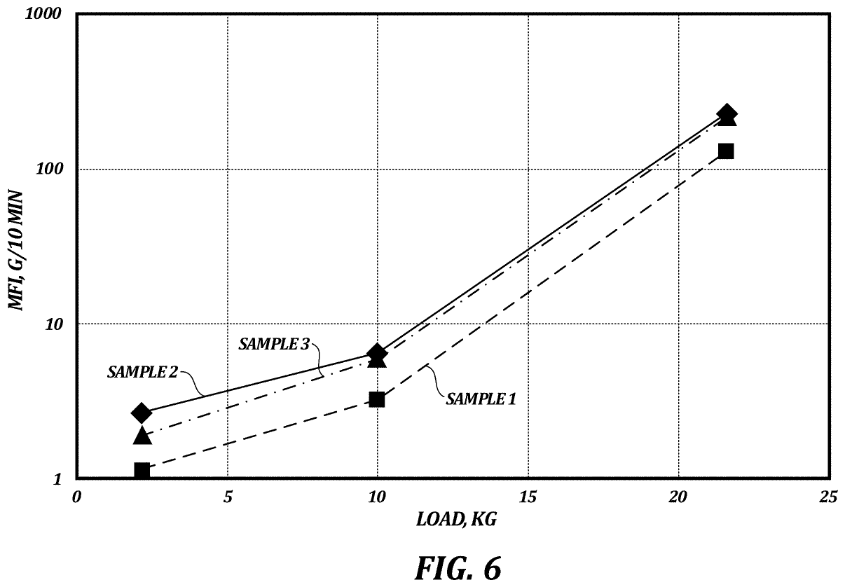

FIG. 7 is a graphical illustration of various physical characteristics of CF polymer composites, in accordance with an embodiment of the disclosure, comparing analogous characteristics of conventional CF polymer composites.

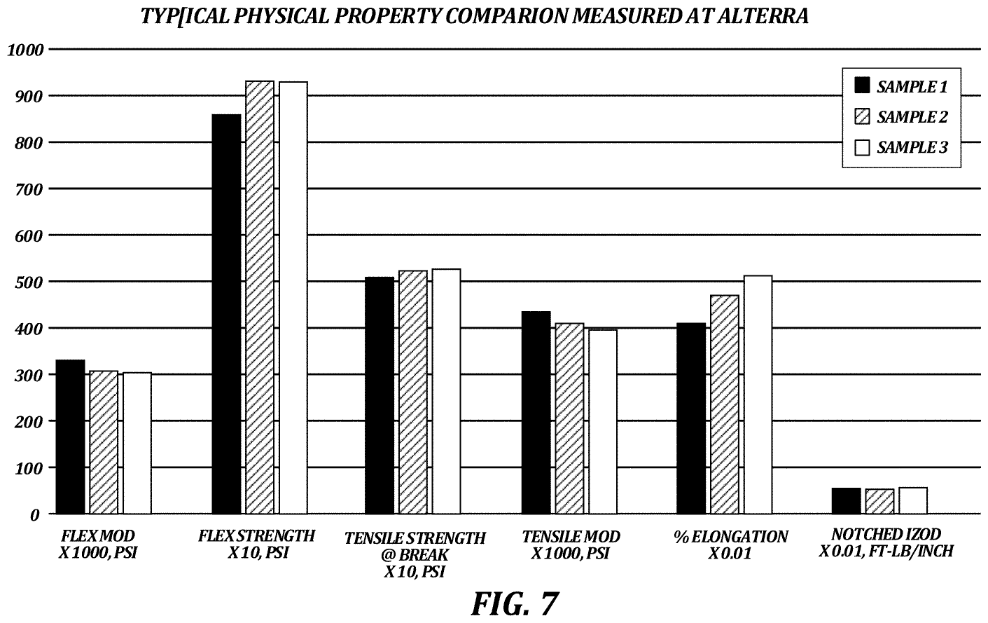

### DETAILED DESCRIPTION

As above, there are problems associated with dispersing cellulose fibers (CFs) throughout a polymeric matrix. Such CFs may be initially in a dried pulp sheet. The drying collapses the CFs. The drying also causes the CFs to bond together through hydrogen bonds. Such hydrogen bonds may be broken or attenuated in order to obtain substantially individual CFs. Nevertheless, some of the CFs may remain bonded or entangled. These are called knots or knits depending on the size. There will usually be a few knots and knits remaining after breaking the hydrogen bonds between CFs.

There are also problems associated with dispersing the CFs at levels of 10 wt % or higher of the total weight of the CF/polymer mix. The smaller amount of polymer makes dispersion of the CF in the polymeric matrix more difficult. The CF/polymer mix becomes more viscous as the amount of CF increases, for example about 35 wt %, and it is, therefore, more difficult to move the fibers within the matrix to provide a dispersion. It is generally desirable to have fewer CF agglomerates.

Toward these ends, the present disclosure is generally directed to CF polymer composites and methods of making CF polymer composites having, inter alia, low levels of CF agglomerates. As set forth in greater detail herein, the composites of the present disclosure have substantially improved CF dispersion compared to conventionally available composites. Further, the composites of the present disclosure, such as those made according to the methods of the present disclosure, also possess improved composite color, such as determined by a Yellowness index, without shortening or without much shortening of a fiber length of a CF feedstock. Improved color is indicative of lower levels of degradation of CF as a result of the method of the present disclosure.

The detailed description set forth in connection with the appended drawings is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

In the following description, numerous specific details are set forth in order to provide a thorough understanding of one or more embodiments of the present disclosure. It will be apparent to one skilled in the art, however, that many embodiments of the present disclosure may be practiced without some or all of the specific details. Further, it will be appreciated that embodiments of the present disclosure may employ any combination of features described herein.

Cellulose Fiber Polymer Composites

In an aspect, the present disclosure provides a CF polymer composite. In an embodiment, the CF polymer composite includes a polymeric matrix; and CFs distributed within the polymeric matrix. As discussed further herein, in an embodiment, the CF polymer composites of the present disclosure have low levels of CF agglomerates compared to conventional CF polymer composites, such as a CF agglomerate count of a 4 g pellet press-out of the CF polymer composite is less than about 25.

Cellulose Fibers

The CF polymer composites of the present disclosure include CFs dispersed in a polymeric matrix. The wood fibers and wood pulp fibers discussed herein, which include CFs, as well as pulps comprising such fibers, are suitable to be used in preparation of the CF polymer composites and the MBs discussed further herein. Such CFs can include CFs from one or more of a number of tree species as the source of the pulp fibers. Coniferous and broadleaf species and mixture of these can be used. These are also known as softwoods and hardwoods. Typical softwood species are various spruces (e.g., Sitka Spruce), fir (Douglas fir), various hemlocks (Western hemlock), tamarack, larch, various pines (Southern pine, Slash pine, White pine, and Caribbean pine), cypress and redwood or mixtures of same. Typical hardwood species are ash, aspen, cottonwood, basswood, birch, beech, chestnut, gum, elm, eucalyptus, maple oak, poplar, and sycamore or mixtures thereof.

The use of softwood or hardwood species may depend in part on the fiber length desired. Hardwood or broadleaf species generally have a fiber length of about 1-2 mm. Softwood or coniferous species generally have a fiber length of about 3.5 to about 7 mm. Douglas fir, grand fir, western hemlock, western larch, and southern pine generally have fiber lengths in a range of about 2 to about 4 mm range. Pulping and bleaching and dicing may reduce the average length because of fiber breakage.

In an embodiment, the CFs of the CF polymer composites and MBs of the present disclosure are derived from a cellulose wood pulp fiber. In an embodiment, the CFs of the CF polymer composites and MBs of the present disclosure are derived from a wood fiber. Cellulose wood pulp fibers differ from wood fibers because the lignin has been removed and some of the hemicellulose has been removed. These materials stay in wood fibers. The amount of material remaining in a wood pulp fiber will depend upon the process of making it. The lumens of the wood pulp fibers collapse during the drying process. The dried chemical wood pulp fibers are flat. The lumens of each of the wood fibers in the wood fiber bundle remain open. The flat wood pulp fibers are more flexible than wood fibers.

In an embodiment, the CFs of the CF polymer composites and MBs of the present disclosure are derived from a mechanical pulp. In a mechanical pulp the fibers are separated by mechanical means, such as grinding, and the process may include steaming and some pre-chemical treatment with sodium sulfite. The lignin is softened to allow the fibers to part. Much of the lignin and hemicellulose, as well as the cellulose, remain with the fiber. The yield, the percentage of material remaining after pulping, is high. The fiber can be bleached with peroxide but this process does not remove much of the material.

In an embodiment, the CFs of the CF polymer composites and MBs of the present disclosure are derived from a chemical pulp. In chemical pulping, the lignin is removed during a chemical reaction between the wood chips and the pulping chemical. Hemicelluloses may also be removed during the reaction. The amount of material being removed will depend upon the chemicals being used in the pulping process. In some embodiments, the Kraft or sulfate process removes less material than the sulfite process or the Kraft process with a pre-hydrolysis stage. The yield is higher in the Kraft process than in the sulfite process or Kraft with pre-hydrolysis. The latter two process have a product with a high percentage of cellulose and little hemicellulose or lignin.

In an embodiment, the CFs of the CF polymer composites and MBs of the present disclosure are derived from a chemical wood pulp fiber. In one embodiment the chemical wood pulp fiber is a bleached chemical wood pulp fiber. Bleaching chemical wood pulp removes more of the lignin and hemicellulose. In the manufacture of pulp, woody material is disintegrated into fibers in a chemical pulping process. The fibers can then optionally be bleached. The fibers are then combined with water in a stock chest to form a slurry. The slurry then passes to a headbox and is then placed on a wire, dewatered and dried to form a pulp sheet. Additives may be combined with the fibers in the stock chest, the headbox or both. Materials may also be sprayed on the pulp sheet before, during or after dewatering and drying. The Kraft pulping process is typically used in the manufacture of wood pulp.

In an embodiment, the CFs of the CF polymer composites and MBs of the present disclosure are derived from cellulosic wood pulp fibers. Cellulosic wood pulp fibers can be in the form of commercial cellulosic wood pulps. The pulp is typically delivered in roll or baled form. In an embodiment, a pulp sheet of the pulp roll has two opposed substantially parallel faces and the distance between these faces will be the thickness of the pulp roll. A typical pulp sheet can have a thickness in a range of about 0.1 mm to about 4 mm. In some embodiments the thickness may be from about 0.5 mm to about 4 mm.

The fiber sheet can have a basis weight in a range of about 12 g/m² to about 2000 g/m², or within any range discussed herein, and all other possible subranges. In one embodiment, the pulp sheet has a basis weight in a range of about 600 g/m² to about 1900 g/m². In another embodiment, the pulp sheet has a basis weight in a range of about 500 g/m² to about 900 g/m². In one embodiment, the pulp sheet has a basis weight in a range of about 70 g/m² to about 120 g/m². In another embodiment, the pulp sheet has a basis weight in a range of about 100 g/m² to about 350 g/m². In another embodiment, the pulp sheet for specialty use has a basis weight in a range of about 350 g/m² to about 500 g/m².

Pulp additives or pretreatment may also change the character of the master batch (MB) and/or CF polymer composite. A pulp that is treated with less debonder will generally provide a looser CF than a pulp that does not have debonders. A looser CF may disperse more readily in the material with which it is being combined.

Polymeric Matrix

The CF polymer composites of the present disclosure include polymeric matrices into which the CFs are distributed. A first material “distributed” or “dispersed” within a second material refers to a first discontinuous material, such as CFs, disposed within a continuous phase domain of the second material, such as a polymeric matrix. As discussed further herein with respect to methods of the present disclosure, the CFs may be distributed into the polymeric matrix through mixing an MB, including the CFs and the polymeric matrix, in a twin-screw extruder. Such mixing can include melt processing and is used to combine the polymeric matrix and CFs. In melt processing, the polymeric matrix is heated above a glass transition of the polymeric matrix such that the polymeric matrix can flow or melt and the CFs are combined with the polymeric matrix. During this process, the CFs may be singulated. In an embodiment, singulated CFs refer to CFs that are substantially separated into individual fibers dispersed in a polymeric matrix. In this regard, singulated CFs may no longer be visible to the naked eye, whereas CF agglomerates are generally visible to a human eye without optical assistance.

A wide variety of polymers are suitable for use as the polymeric matrix. In an embodiment, the polymeric is thermoplastic. In an embodiment, the polymeric matrix is hydrophobic. In an embodiment, the polymeric matrix is hydrophilic. Such polymers can include both hydrocarbon and non-hydrocarbon polymers. Examples of polymers suitable for use in a polymeric matrix as used herein can include, but are not limited to, high density polyethylene (HDPE), low density polyethylene (LDPE), linear low density polyethylene (LLDPE), polypropylene (PP)), polyolefin copolymers (e.g., ethylene-butene, ethylene-octene, ethylene vinyl alcohol), polystyrene, polystyrene copolymers (e.g., high impact polystyrene, acrylonitrile butadiene styrene copolymer), polyacrylates, polymethacrylates, polyesters, polyacrylonitrile, polyoxymethylene, polyvinylchloride (PVC), fluoropolymers, Liquid Crystal Polymers, polyamides, polyether imides, polyphenylene sulfides, polysulfones, polyacetals, polycarbonates, polyphenylene oxides, polyurethanes, thermoplastic elastomers, epoxies, alkyds, melamines, phenolics, ureas, vinyl esters, copolymers thereof, and combinations thereof. In an embodiment, the polymer(s) of the polymeric matrix includes one or more biodegradable polymers, such as polyhydroxyalkanoates, furandicarboxylic acid-based renewable polymers, such as polyolefin furanoates, ethylene glycol furanoates, copolymers thereof, and combinations thereof. In certain embodiments, the most suitable polymeric matrices are polyolefins. In an embodiment, the polymeric matrix includes a polymer selected from the group consisting of polylactic acid, cellulose acetate, cellulose propionate, cellulose butyrate; polycarbonate, polyethylene terephthalate, high-density polyethylene, low-density polyethylene, polypropylene, polystyrene, polystyrene, polyhydroxyalkanoate, polyolefin furanoate, ethylene glycol furanoate, styrene block copolymers, polyvinyl chloride, cellulose acetate, polyvinylidene chloride, copolymers thereof, and combinations thereof. In some embodiments the following thermoplastic polymers may be used in a polymeric matrix: biopolymers such as polylactic acid (PLA), polyhydroxy alkanoates, renewable polymers based on Furandicarboxylic acids, such polyolefin furanoate and ethylglycol furanoate copolymers, cellulose acetate, cellulose propionate, cellulose butyrate; polycarbonates, polyethylene terephthalate, polyolefins such as polyethylene, high density polyethylene, low density polyethylene, linear low density polyethylene, polypropylene, polystyrene, polystyrene copolymers such as acrylonitrile-butadiene-styrene copolymer (ABS), styrene block copolymers, polyvinyl chloride (PVC), and recycled plastics.

Polymeric matrices that are derived from recycled plastics are also applicable, as they are often lower cost. However, because such materials are often derived from materials coming from multiple waste streams, they may have vastly different melt rheology. The addition of cellulosic feedstock to a recycled polymeric matrix should increase the melt viscosity and reduce overall variability, thus improving processing. Likewise, such recycled polymers can include dyes or other colored components, which can add color to the composite itself.

As above, in an embodiment, the polymeric matrix is a hydrophobic polymeric matrix. Such a hydrophobic polymeric matrix may provide additional challenges to dispersion of the CFs, where such CFs are generally hydrophilic. However, the methods of the present disclosure, which include mixing an MB in a twin-screw extruder, are suitable to provide CF polymer composites having low CF agglomerate counts, such as less than about 25, generally overcoming these challenges.

In an embodiment, the polymeric matrix has a surface energy of less than about 35 dynes/cm. In an embodiment, the polymeric matrix has a surface energy of less than about 30 dynes/cm. In an embodiment, the polymeric matrix has a surface energy of less than about 25 dynes/cm. Surface energy of the polymeric matrix can be measured by any known methods. In an embodiment, surface energy of the polymeric matrix is measured using the sessile drop technique, including measuring a contact angle between the sessile drop and a surface, such as according to ASTM D2578-17. Such measurements made using the sessile drop technique can incorporate use of sessile drops of various probe liquids, such as formamide, diiodomethane, and water. Further, calculations made using the sessile drop technique can be performed using different theories, such as the Zisman theory, the Owens/Wendt theory, the Fowkes theory, the Wu theory, and the Schultz theory, to name a few. In an embodiment, a contact angle between the sessile drop and the surface of the polymeric matrix is greater than about 80 degrees. In an embodiment, a contact angle between the sessile drop and the surface of the polymeric matrix is greater than about 85 degrees. In an embodiment, a contact angle between the sessile drop and the surface of the polymeric matrix is greater than about 90 degrees. In an embodiment, a contact angle between the sessile drop and the surface of the polymeric matrix is greater than about 95 degrees.

### Compatibilizers and Modifiers

The polymeric matrix of the CF polymer composites of the present disclosure can include one or more additives, suitable to modify physical characteristics of the CF polymer composites.

In an embodiment, the CF polymer composites of the present disclosure include a compatibilizing agent and/or coupling agent. Such compatibilizing agents are typically used to improve interfacial wetting of fillers, such as CFs, with a polymeric matrix. Addition of coupling agents or compatibilizing agents often improves the mechanical properties of the resulting composite material. In an embodiment, the CF polymer composites, MBs, and/or methods of the present disclosure include compatibilizing agents to improve wetting between the CFs and the polymeric matrix. As discussed further herein with respect to TABLE 1B, in an embodiment, the MBs comprise CFs coated in a polymer matrix including a compatibilizing agent and/or coupling agent. The addition of a compatiblizing agent improves dispersion of the CF feedstock with polymer matrices. Compatibilizing agents and coupling agents are sometimes used interchangeably even though they perform differently to provide compatibility between the two materials.

Preferred compatibilizing agents, such as for use with polyolefins, include polyolefin-graft-maleic anhydride copolymers or terpolymers. In one embodiment, the CFs are mixed, such as by melt processing, with a polyolefin-graft-maleic anhydride copolymer to prepare an MB as discussed further herein. Commercially available compatibilizing agents suitable for the MB, CF polymer composites, and methods of the present disclosure include those sold under the tradenames Polybond™ (Chemtura), Exxelor™ (Exxon Mobil), Fusabond™ (DuPont), Lotader™ (Arkema), Bondyram™ (Maroon), Integrate (Lyondellbasell), Genioplast™ such as SLM446402 and 20A03 (Wacker Chemie) etc. In an embodiment, the polyolefin in the graft copolymer is the same as the polyolefin used as a thermoplastic polymer mixed with the MB. For example, polyethylene-graft-maleic anhydride would be used with polyethylene and polypropylene-graft-maleic anhydride would be used with polypropylene. In one embodiment, the CF polymer composite includes a compatibilizing agent in an amount in a range of about 5-10%, or within any range discussed herein, and all other possible subranges. In another embodiment, an amount of the compatibilizing agent is in a range of about 0.2-5%. In an embodiment, the CF polymer composite includes a compatibilizing agent in an amount in a range of about 0.5% to about 4%. In an embodiment, the CF polymer composite includes a compatibilizing agent in an amount in a range of about 1% to about 3%. In an embodiment, the CF polymer composite includes a compatibilizing agent in an amount in a range of about 2% to about 3%.

The polymeric matrix may contain one or more fillers in addition to the CF feedstock. Fillers and fibers other than CFs may be added to the CF polymer composites and MB to impart desirable physical characteristics or to reduce the amount of polymer needed for a given application. Fillers often contain moisture and therefore reduce efficacy of a compatibilizing agent present in a polymeric matrix. Non-limiting examples of fillers and fibers include wood flour, natural fibers other than chemical wood pulp fiber, glass fiber, carbon fibers, calcium carbonate, talc, silica, and various types of exfoliated clays, magnesium hydroxide, and aluminum trihydroxide.

In an embodiment, the CF polymer composites include other additives. Non-limiting examples of additives include compatibilizing agents, coupling agents, anti-oxidants, dispersive agents, anti-slip agents, anti-static agents, antioxidants, light stabilizers, fibers, blowing agents, foaming additives, antiblocking agents, heat and UV light stabilizers, impact modifiers, biocides, flame retardants, plasticizers, tackifiers, colorants, processing aids, lubricants, compatibilizing agents, and pigments. The additives may be incorporated into the MB used to make the CF polymer composite in the form of powders, pellets, granules, or in any other extrudable or compoundable form. The amount and type of conventional additives in the MB varies depending upon the polymeric matrix and the desired physical properties of the finished composition. Those skilled in the art are capable of selecting appropriate amounts and types of additives to match with a specific polymeric matrix in order to achieve desired physical properties of the finished material.

Cellulose Fiber Polymer Composite Characteristics

As discussed further herein, it has been surprisingly found that CF polymer composites derived mixing an MB in a twin-screw extruder have advantageous properties that lend themselves, for example, to injection molding. In this regard, the CF polymer composites of the present disclosure are shown, such as in the Examples and Tables set forth below, to have improved properties compared to conventional composites.

In an embodiment, the CF polymer composite described herein have a CF agglomerate count of less than about 25 in a 4 g press-out of the CF composite pellets, such as in a range of greater than 0 to 24, or within any range discussed herein, and all other possible subranges. In an embodiment, the CF agglomerate count of a 4 g melt-pressed pellet is in a range of about 5 to about 24. In an embodiment, the CF agglomerate count of a 4 g melt-pressed pellet is in a range of about 5 to about 15. In an embodiment, the CF agglomerate count of a 4 g melt-pressed pellet is in a range of about 10 to about 15. In an embodiment, the CF agglomerate count of a 4 g melt-pressed pellet is in a range of about 5 to about 10. Such CF agglomerate counts can be measured according to the methods described in Example 3.

Without wishing to be bound by theory, it is believed that mixing the MB in the twin-screw extruder intimately mixes the CFs to distribute the fibers within the polymeric matrix with low levels of CF aggregation. As shown in Table 3, the CF polymer composites of the present disclosure have lower CF agglomerate counts than those of conventional composites, such as those made according to different methods.

In an embodiment, the CF polymer composites of the present disclosure are further relatively free of color, such as where the polymeric matrix has lower Yellowness Index (YI). Accordingly, a user is free to modify a CF polymer composite of the present disclosure to have any desired color without constraint from an inherent color of the CF polymer composite. In that regard, in an embodiment, a YI of the CF polymer composite is less than about 32. As shown in Table 3, the CF polymer composites of the present disclosure have a YI that is lower than that of conventional composites. In an embodiment, a YI of the CF polymer composite is in a range of about 20 to about 30, or within any range discussed herein, and all other possible subranges. In an embodiment, a YI of the CF polymer composite is in a range of about 20 to about 25. In an embodiment, a YI of the CF polymer composite is in a range of about 10 to about 25. In an embodiment, a YI of the CF polymer composite is in a range of about 10 to about 15. Such Yellowness indices can be measured according the procedures set forth in in the Examples below, such as according to ASTM D1925.

Without wishing to be bound by theory, it is believed that mixing the MB with the twin-screw extruder is suitable to intimately mix the CFs with the polymeric matrix sufficient to distribute the CFs within the polymeric matrix without degrading or with minimal degradation of the CFs. As discussed further herein with respect to the methods of the present disclosure, the twin-screw extruder may be operated in a way to avoid or mitigate CF degradation, such as by mixing the MB in a relatively gentle way. Degradation of the CFs can contribute to a yellowing of the CF polymer composite. By mixing without or with little CF degradation, the relatively color-free CF polymer composites of the present disclosure having a relatively low YI can be achieved.

As discussed further herein, Melt Flow Index (MFI) is a measure of ease of flow of molten thermoplastic polymer at a given temperature and may be used to assess batch-to-batch variation. In an embodiment, the CF polymer composites of the present disclosure have an MFI that is generally higher than MFI of conventional composites. See, for example, Table 3. In this regard, the CF polymer composites of the present disclosure have a lower viscosity than conventional composites making them better suited, for example, for injection molding.

In an embodiment, the CF polymer composites of the present disclosure have an MFI in a range of about 1.9 g/10 min to about 5.6 g/10 min measured at a load of 2.16 kg at 210° C., or within any range discussed herein, and all other possible subranges. In an embodiment, the CF polymer composites of the present disclosure have an MFI in a range of about 2.0 g/10 min to about 3.0 g/10 min measured at a load of 2.16 kg at 210° C. In an embodiment, the CF polymer composites of the present disclosure have an MFI in a range of about 5.0 g/10 min to about 6.0 g/10 min measured at a load of 2.16 kg at 210° C. In an embodiment, the CF polymer composites of the present disclosure have an MFI in a range of about 1.5 g/10 min to about 3.0 g/10 min measured at a load of 2.16 kg at 210° C.

In an embodiment, the CF polymer composites of the present disclosure have an MFI in a range of about 5.0 g/10 min to about 51.0 g/10 min measured at a load of 10.0 kg at 210° C., or within any range discussed herein, and all other possible subranges. In an embodiment, the CF polymer composites of the present disclosure have an MFI in a range of about 5.0 g/10 min to about 7.0 g/10 min measured at a load of 10.0 kg at 210° C. In an embodiment, the CF polymer composites of the present disclosure have an MFI in a range of about 5.5 g/10 min to about 6.5 g/10 min measured at a load of 10.0 kg at 210° C. In an embodiment, the CF polymer composites of the present disclosure have an MFI in a range of about 45.0 g/10 min to about 55.0 g/10 min measured at a load of 10.0 kg at 210° C.

In an embodiment, the CF polymer composites of the present disclosure have an MFI in a range of about 80 g/10 min to about 250 g/10 min measured at a load of 21.6 kg at 210° C., or within any range discussed herein, and all other possible subranges. In an embodiment, the CF polymer composites of the present disclosure have an MFI in a range of about 200 g/10 min to about 250 g/10 min measured at a load of 21.6 kg at 210° C. In an embodiment, the CF polymer composites of the present disclosure have an MFI in a range of about 210 g/10 min to about 230 g/10 min measured at a load of 21.6 kg at 210° C. In an embodiment, the CF polymer composites of the present disclosure have an MFI in a range of about 215 g/10 min to about 240 g/10 min measured at a load of 21.6 kg at 210° C. In an embodiment, the CF polymer composites of the present disclosure have an MFI in a range of about 220 g/10 min to about 240 g/10 min measured at a load of 21.6kg at 210° C.

As discussed further herein, Rheology Process Index (RPI) is a parameter that predicts the processability of a composite. In an embodiment, the CF polymer composites of the present disclosure have an RPI in a range of about 60 to about 250, or within any range discussed herein, and all other possible subranges. In an embodiment, the CF polymer composites of the present disclosure have an RPI in a range of about 200 to about 250. In an embodiment, the CF polymer composites of the present disclosure have an RPI in a range of about 100 to about 115. In an embodiment, the CF polymer composites of the present disclosure have an RPI in a range of about 85 to about 115. In an embodiment, the CF polymer composites of the present disclosure have an RPI in a range of about 110 to about 115. In an embodiment, the CF polymer composites of the present disclosure have an RPI in a range of about 60 to about 90.

In an embodiment, a CF length of an in-molded CF polymer composite, in accordance with an embodiment of the disclosure, is generally ⅓ of the length of cellulose fibers of the feed stock CF used to prepare the MB. Typically, the widths of the fibers in polymer composite are similar to the feed stock. Without wishing to be bound by theory, it is believed that mixing an MB with neat polymer in a twin-screw extruder, as described further herein with respect to the methods of the present disclosure, is suitable to intimately mix the CFs and the polymeric matrix to achieve low CF aggregate numbers without or with little degradation of the CFs. In this regard, the CFs distributed within the polymeric matrix are relatively long with high aspect ratio.

In an embodiment, CFs dispersed in the polymeric matrix have a weighted number average CF length (L_{w}) in a range of about 600 μm to about 1,200 μm, or within any range discussed herein, and all other possible subranges. In an embodiment, CFs dispersed in the polymeric matrix have an L_{w} in a range of about 400 μm to about 600 μm. In an embodiment, CFs dispersed in the polymeric matrix have an L_{w} in a range of about 400 μm to about 800 μm. In an embodiment, CFs dispersed in the polymeric matrix have an L_{w} in a range of about 600 μm to about 1,000 μm. In an embodiment, CFs dispersed in the polymeric matrix have an L_{w} in a range of about 600 μm to about 800 μm. In an embodiment, CFs dispersed in the polymeric matrix have an L_{w} in a range of about 800 μm to about 1,000 μm. In an embodiment, CFs dispersed in the polymeric matrix have an L_{w} in a range of about 600 μm to about 700 μm. The average CF length can be measured according to the method described further herein with respect to Example 5.

In an embodiment, the CFs dispersed in the polymeric matrix have an average CF width in a range of about 10 μm to about 40 μm, or within any range discussed herein, and all other possible subranges. In an embodiment, the CFs dispersed in the polymeric matrix have an average CF width in a range of about 10 μm to about 20 μm. In an embodiment, the CFs dispersed in the polymeric matrix have an average CF width in a range of about 18 μm to about 36 μm. In an embodiment, the CFs dispersed in the polymeric matrix have an average CF width in a range of about 10 μm to about 30 μm. In an embodiment, the CFs dispersed in the polymeric matrix have an average CF width in a range of about 15 μm to about 25 μm. In an embodiment, the CFs dispersed in the polymeric matrix have an average CF width in a range of about 20 μm to about 40 μm. The average CF width can be measured according to the method described further herein with respect to Example 5.

As shown in Table 4, the CF polymer composites of the present disclosure have flexural and tensile strengths and moduli comparable to or greater than those of conventional composites.

In an embodiment, a flexural modulus of the CF polymer composite is in a range of about 200,000 pounds per square inch (psi) to about 400,000 psi, or within any range discussed herein, and all other possible subranges. In an embodiment, a flexural modulus of the CF polymer composite is in a range of about 300,000 psi to about 305,000 psi. In an embodiment, a flexural modulus of the CF polymer composite is in a range of about 305,000 psi to about 310,000 psi. In an embodiment, a flexural modulus of the CF polymer composite is in a range of about 295,000 psi to about 300,000 psi. In an embodiment, a flexural modulus of the CF polymer composite is in a range of about 300,000 psi to about 310,000 psi.

In an embodiment, a flexural strength of the CF polymer composite is in a range of about 7,000 psi to about 11,000 psi, or within any range discussed herein, and all other possible subranges. In an embodiment, a flexural strength of the CF polymer composite is in a range of about 7,000 psi to about 9,400 psi. In an embodiment, a flexural strength of the CF polymer composite is in a range of about 9,200 psi to about 11,000 psi. In an embodiment, a flexural strength of the CF polymer composite is in a range of about 9,200 psi to about 9,400 psi. In an embodiment, a flexural strength of the CF polymer composite is in a range of about 9,300 psi to about 9,500 psi.

In an embodiment, a tensile strength at break of the CF polymeric matrix is in a range of about 3,000 psi to about 7,500 psi, or within any range discussed herein, and all other possible subranges. In an embodiment, a tensile strength at break of the CF polymeric matrix is in a range of about 3,000 psi to about 5,400 psi. In an embodiment, a tensile strength at break of the CF polymeric matrix is in a range of about 5,100 psi to about 7,000 psi. In an embodiment, a tensile strength at break of the CF polymeric matrix is in a range of about 5,200 psi to about 5,500 psi. In an embodiment, a tensile strength at break of the CF polymeric matrix is in a range of about 5,200 psi to about 5,400 psi.

In an embodiment, a tensile modulus of the CF polymeric matrix is in a range of about 300,000 psi to about 550,000 psi, or within any range discussed herein, and all other possible subranges. In an embodiment, a tensile modulus of the CF polymeric matrix is in a range of about 300,000 psi to about 409,000 psi. In an embodiment, a tensile modulus of the CF polymeric matrix is in a range of about 400,000 psi to about 405,000 psi. In an embodiment, a tensile modulus of the CF polymeric matrix is in a range of about 405,000 psi to about 410,000 psi. In an embodiment, a tensile modulus of the CF polymeric matrix is in a range of about 405,000 psi to about 435,000 psi.

In an embodiment, a percent elongation at break of the CF polymer composite is in a range of about 4.0% to about 6.5%, or within any range discussed herein, and all other possible subranges. In an embodiment, a percent elongation at break of the CF polymer composite is in a range of about 4.5% to about 5.0%. In an embodiment, a percent elongation at break of the CF polymer composite is in a range of about 5.0% to about 6.5%. In an embodiment, a percent elongation at break of the CF polymer composite is in a range of about 4.7% to about 5.2%.

### Methods of Making Composites

In another aspect, the present disclosure provides a method of making a CF polymer composite. In an embodiment the method of the present disclosure is suitable to prepare the CF polymer composites of the present disclosure discussed, for example, herein above.

In an embodiment, the method of the present disclosure includes introducing an MB into a twin-screw extruder. In an embodiment, the MB includes a polymeric matrix and CFs coated in the polymeric matrix. While the MBs of the present disclosure are described as CFs coated in a polymeric matrix, such MBs can also include CFs blended with or otherwise mixed with polymeric matrices. Such an MB need not have the relatively low CF agglomerate counts of the CF polymer composites of the present disclosure. Rather, the MB can simply be a mixture or dispersion of the polymeric matrix and the CF, which is subsequently mixed in a twin-screw extruder.

In an embodiment, the polymeric matrix includes a material selected from the group consisting of a thermoplastic polymer, one or more additives, such as coupling agents and/or compatibilizing agents, a wax, an antioxidant, and combinations thereof. In an embodiment, the polymeric matrix includes a thermoplastic polymer, such as one or more thermoplastic polymers described further herein with respect to the CF polymer composites of the present disclosure. In an embodiment, the polymeric matrix does not include a thermoplastic material, as discussed further herein with respect to TABLES 1A and 1B. In an embodiment, the polymeric matrix comprises a compatibilizing agent and/or a coupling agent. Such compatibilizing agents and coupling agents include compatibilizing agents and coupling agents discussed further herein with respect to the CF polymer composites of the present disclosure.

It has been surprisingly found that by introducing such an MB into the twin-screw extruder that a resultant CF polymer composite has low numbers of CF agglomerates when compared to conventional CF polymer composites, such as wherein a CF agglomerate count of a 4 g pellet of the cellulose fiber polymer composite of the present disclosure is less than about 25. In an embodiment, the MB is introduced directly into the twin-screw extruder.

As above, such an MB can include, for example, a polymeric matrix, such as a hydrophobic polymer matrix, and CFs coated within the polymeric matrix. In an embodiment, the MB includes CFs in a range of about 65 wt % to about 95 wt %, or within any range discussed herein, and all other possible subranges. In an embodiment, the MB includes CFs in a range of about 65 wt % to about 80 wt %. In an embodiment, the MB includes CFs in a range of about 80 wt % to about 95 wt %.

In an embodiment, the polymeric matrix includes a polymer selected from the group consisting of polylactic acid, cellulose acetate, cellulose propionate, cellulose butyrate; polycarbonate, polyethylene terephthalate, high-density polyethylene, low-density polyethylene, polypropylene, polystyrene, polystyrene, polyhydroxyalkanoate, polyolefin furanoate, ethylene glycol furanoate, styrene block copolymers, polyvinyl chloride, cellulose acetate, polyvinylidene chloride, copolymers thereof, and combinations thereof.

In an embodiment, the method includes a step of forming an MB. In this regard, in an embodiment, the method includes forming the MB by mixing the plurality of CFs and the polymeric matrix to coat the CFs with the polymeric matrix. The MB can be made according to any method that provides a CFs coated, blended, or otherwise mixed with the polymeric matrix. The CFs need not be evenly or intimately distributed in the MB, such as according to the distribution metrics of the CF polymer composites of the present disclosure. In this regard, mixing the MB in the twin-screw extruder provides such distribution.

Forming the MB can include mixing CFs and the polymeric matrix in one or more of a pellet mill, twin- or single-screw extruder. In an embodiment, the MB resulting from, for example, the pellet mill, twin- or single-screw extruder is the form of a pellet. Such pellets are suitable for introduction into a twin-screw extruder. Accordingly, in an embodiment, the method includes introducing the MB in the form of one or more pellets into the twin-screw extruder. Such pellets may be advantageously added to the twin-screw extruder in a controlled or metered fashion, such that an amount of MB in the twin-screw extruder is correspondingly controlled.

The method can further include introducing additional polymeric matrix, such as a thermoplastic polymeric material, in addition to any thermoplastic polymer in the polymeric matrix in the MB, into the twin-screw extruder. Such additional polymeric matrix can be introduced with the MB into the twin-screw extruder. In an embodiment, the additional polymeric matrix is introduced into the twin-screw extruder at a different position or at a different time from the place or time of introducing the MB to the twin-screw extruder. Such additional polymeric matrix can be used to dilute the CFs in the CF polymer composite formed by the method. Such additional polymeric matrix, such as a thermoplastic polymeric material, can be the same as or different from the polymeric matrix used to form the MB. In an embodiment, the thermoplastic polymeric material is a thermoplastic polymer discussed further herein with respect to the CF polymer composites of the present disclosure. In an embodiment, the thermoplastic polymeric material is a hydrophobic polyolefin, such as polypropylene.

As above, in an embodiment, the MB includes an additive selected from the group consisting of a compatibilizing agent, a coupling agent, an anti-oxidant, a lubricant, processing aid, UV and light stabilizers, acid scavengers and combinations thereof. In an embodiment, such additives are suitable to change a physical characteristic of a resultant CF polymeric matrix. In an embodiment, the compatibilizing agent includes a polyolefin-graft-maleic anhydride copolymer or terpolymer. As above, in an embodiment, the MB includes only additives as described herein and CFs distributed therein.

The method of the present disclosure includes mixing the MB in the twin-screw extruder to form the CF polymer composite. In an embodiment, mixing the MB in the twin-screw extruder includes rotating twin screws of the twin-screw extruder at a rotation frequency in a range of about 50 rotations per minute (RPM) to about 800 RPM, or within any range discussed herein, and all other possible subranges. In an embodiment, mixing the MB in the twin-screw extruder includes rotating twin screws of the twin-screw extruder at a rotation frequency in a range of about 250 RPM to about 450 RPM. In an embodiment, mixing the MB in the twin-screw extruder includes rotating twin screws of the twin-screw extruder at a rotation frequency in a range of about 300 RPM to about 400 RPM. In an embodiment, mixing the MB in the twin-screw extruder includes rotating twin screws of the twin-screw extruder at a rotation frequency in a range of about 350 RPM to about 400 RPM. In an embodiment, mixing the MB in the twin-screw extruder includes rotating twin screws of the twin-screw extruder at a rotation frequency in a range of about 300 RPM to about 450 RPM.

Mixing the MB, including the CFs and the polymeric matrix, in the twin-screw extruder can include mixing the MB in two or more blocks of the twin-screw extruder that has a relatively long screw length/screw diameter (L/D) ratio and various distributive and dispersive mixing and kneading blocks. In an embodiment, mixing the MB in the twin-screw extruder includes passing the MB in one or more kneading blocks of the twins-crew extruder configured to mix the MB and move the MB, including the plurality of CFs and polymeric matrix, through the twin-screw extruder. In an embodiment, mixing the MB in the twin-screw extruder includes introducing the MB into one or more sections of the twin-screw extruder configured to mix the MB and move the mixed CFs and polymeric matrix through the twin-screw extruder. Various distributive and dispersive screw designs in combination with kneading blocks are suitable to intimately mix the MB, including the plurality of CFs, while mitigating degradation of the CFs and Yellowness of the resultant CF polymer composite.

In addition to providing CF polymer composites having low numbers of CF agglomerates and low color, mixing the MBs in a twin-screw extruder also produce CF polymer composites at relatively high rates when compared with conventional methods of making CF polymer composites. In an embodiment, the methods described herein are suitable to produce the CF polymer composite at a rate in a range of about 500 lbs/hour to about 2,000 lbs/hour, or within any range discussed herein, and all other possible subranges. In an embodiment, the methods described herein are suitable to produce the CF polymer composite at a rate in a range of about 800 lbs/hour to about 1,000 lbs/hour. In an embodiment, the methods described herein are suitable to produce the CF polymer composite at a rate in a range of about 1,000 lbs/hour to about 1,200 lbs/hour.

As above, the method of the present disclosure is suitable to prepare the CF polymer composite of the present disclosure. In this regard, the method of the present disclosure is suitable to prepare a CF polymer composite having one or more of the following characteristics:
a CF agglomerate count of a 4 g pellet of the cellulose fiber polymer composite is less than about 25;
a YI of the CF polymer composite is less than about 32;
a melt flow rate of the CF polymer composite measured at a load of 21.6 kg is in a range of about 80 g/10 min to about 250 g/10 min measured at 210° C.;
a rheology processing index of the CF polymer composite is in a range of about 60 to about 250;
the CFs have an average CF length in a range of about 600 μm to about 1,200 μm;
the CFs have an average CF width in a range of about 18 μm to about 36 μm;
a flexural modulus of the CF polymer composite is in a range of about 200,000 pounds per square inch (psi) to about 400,000 psi;
a flexural strength of the CF polymer composite is in a range of about 7,000 psi to about 11,000 psi;
a tensile strength at break of the CF polymeric matrix is in a range of about 3,000 psi to about 7,500 psi; and
a tensile modulus of the CF polymeric matrix is in a range of about 300,000 psi to about 550,000 psi.

### EXAMPLES

### Example 1: Master Batch Preparation

MBs were produced in a pellet mill, twin- or single-screw extruder. The CF, processing aid, various additives, and compatibilizers were fed together and compacted into semi-pellet shaped particles.

### Example 2: Twin Screw Extruder Mixing

MBs, prepared as described above, were introduced into a twin-screw extruder and mixed according to the conditions described in Table 2.

TABLE 1A
Composite formulation

| Sample Number | Sample 2 | Sample 3 | Sample 4 |
|---|---|---|---|
| Homopolymer PP(virgin) | 75.72 | 75.72 | 0 |
| Homopolymer PP (recycled white) | 0 | 0 | 75.72 |
| MB | 23.53 | 23.53 | 23.53 |
| Other additives | 0.75 | 0.75 | 0.75 |
| TOTAL % | 100 | 100 | 100 |

TABLE 1B
Master batch Formulation

| Composition | Wt % range |
|---|---|
| CF | 85 |
| Compatibilizers | 12.5 |
| Other additives | 2.5 |

TABLE 2
Process conditions

| Lot | Sample 2 | Sample 3 | Sample 4 |
|---|---|---|---|
| TOTAL RATE | 800 | 1,000 | 800 |
| lb./hr. | | | |
| RPM | 350 | 400 | 425 |
| Barrel temperature | 250 | 250 | 250 |
| (° F.) | | | |
| Zone 2 | | | |
| Zone 3 | 250 | 250 | 250 |
| Zone 4 | 250 | 250 | 250 |
| Zone 5 | 320 | 320 | 320 |
| Zone 6 | 320 | 320 | 320 |
| Zone 7 | 320 | 320 | 320 |
| Zone 8 | 320 | 320 | 320 |
| Zone 9 | 320 | 320 | 320 |
| Zone 10 | 320 | 320 | 320 |
| Zone 11 | 320 | 320 | 320 |
| Zone 12 | 320 | 320 | 320 |
| Zone 13 | 320 | 320 | 320 |
| Zone 14 | 340 | 340 | 340 |
| Die temperature | 340 | 340 | 340 |
| (° F.) | | | |

### Example 3: Dispersion Testing

Dispersion testing of the CF polymer composites was tested according to the testing procedures described below.

Measurement of dispersion is accomplished by using ImageJ (NIH). ImageJ is freeware that can be downloaded at http//imagej.nih.gov/ij/download.html. The Erode, Subtract Background, Analyze Particles and the other commands used in the custom macro below are standard commands in ImageJ. The macro simply uses the standard IMageJ commands in a given order to obtain the information.

4 g of composite pellet samples are compression molded. The press-outs are scanned to a digital image using an office photocopier. Digital image is analyzed using ImageJ software

The custom macro locates the samples in the image. It then performs the Erode command four times to remove sample edge artifacts. It applies the Subtract Background command with a rolling ball diameter of 5 pixels, a light background and smoothing disabled. The grayscale image is converted to black and white by using a threshold value supplied by the user. A typical threshold value is 241.

The image now has black particles which correspond to undispersed fibers. The particles are counted using the Analyze Particles command. All particles except those touching the edge are counted. This is because there are often edge effects that look like a particle to the macro but are not actually a particle.

The other assumption is that the diced wood pulp material provided to the process will divide or delaminate once along a center line and these divided particles may also divide or delaminate once along a center line. The macro assumes that one-half of the analyzed particles will have divided or delaminated once and the other half will have divided or delaminated twice.

The macro reports the area of the undispersed particles. The macro assumes that one-half of the total area is occupied by once divided undispersed particles and one-half of the total area is occupied by twice divided particles.

The total weight of the undispersed particles or fibers is then calculated. In the following discussion a pulp sheet having a basis weight of 750 grams per square meter (gsm) is used. The macro assumes the basis weight of one-half of the particles, the once divided particles, have a basis weight of 375 gsm and the other half of the analyzed particles, the twice divided particles, have a basis weight of 187 gsm. The total weight of the undispersed particles or fibers is determined by the following formula:

Weight undispersed particles=0.0001*[0.5*(area of undispersed particles)cm²*(375 gsm)+0.5*(area of undispersed particles)cm²*(187 gsm)]

The weight percent of undispersed particles is found by the following formula:

Weight % undispersed particles=100*Weight undispersed particles/Total weight of fibers in sample

The weight percent of dispersed fibers is found by subtracting the weight percent of undispersed particles from 100 percent.

The actual macro is:

//HOW MANY SPECIMENS ARE IN THE IMAGE?
N=10;
//Now run the macro
run(“8-bit”);
run(“Rotate 90 Degrees Right”);
run(“Select All”);
run(“Copy”);
run(“Internal Clipboard”);
setThreshold(0,200);
run(“Convert to Mask”);
k=1;//initialize k to 1
P=4;//number of Erode operations to perform

while (k<=P) { //this loop does multiple Erodes
run(“Erode”);
k=k+1;
}

run(“Analyze Particles...”, “size=0-Infinity

circularity=0.00-1.00

show=Nothing clear record add”);
run(“Internal Clipboard”);
run(“Subtract Background...”, “rolling=5 light disable”);
selectWindow(“Clipboard”);
run(“Create Selection”);
selectWindow(“Clipboard−1”);
run(“Restore Selection”);
//THE USER MUST SET THE THRESHOLDING

VALUE. 241

USUALLY WORKS WELL.
setThreshold(0, 241);
run(“Convert to Mask”);
run(“Make Binary”);
k=0;
M=N−1;//we count up from 0 not 1

while (k<=M) { //this loop does multiple Analyze

Particles

roiManager(“Select”, k);
run(“Analyze Particles...”, “size=0-Infinity
circularity=0.00-1.00 show=Nothing
exclude summarize”);
k=k+1;
}

close( );
close( );

Dispersion can depend on the amount of fiber loading.

Table 3 provides dispersion metrics for the tested CF polymer composites, along with other metrics tested as described further herein.

TABLE 3
Cellulose Fiber Polymer Composite Metrics

| | Propel | Sample 1 | Sample 2 | Sample 3 | Sample 4 |
|---|---|---|---|---|---|
| CF agglomerates count | 126 ± 28 | 26 ± 8 | 13 ± 6 | 6 ± 2 | 14.5 ± 3.5 |
| (IP test method) | | | | | |
| YI (ASTM D1925) | Black | 33 | 24 | 26 | 23.4 |
| CF size length, mm | 0.53 ± 0.48 | 0.86 ± 0.58 | 0.61 ± 0.68 | 0.68 ± 0.50 | 0.62 ± 0.40 |
| (avg. of 400 fiber | | | | | |
| count) - IP test method | | | | | |
| CF width, μm - IP test | 23-66 | 22-36 | 30 | 20.8 | 31.4 |
| method | | | | | |
| MFI@ 2.16 kg | N/A | 1.15 | 2.64 | 1.93 | 5.55 |
| MFI @ 10 kg | N/A | 3.24 | 6.38 | 5.96 | 50.4 |
| MFI @ 21.6 kg | N/A | 128.28 | 227.64 | 214.40 | *** |
| Rheology processing | N/A | 111 | 86 | 111 | *** |
| Index (RPI) | | | | | |

*** At 21.6 kg load Sample 4 viscosity is so low that it could not be measured by the MI machine. This is an indication of very low viscosity of Sample 4 compared to the conventional composite materials.

As shown, the CF polymer composites of the present disclosure have low CF agglomerate counts and low Yellowness indices compared to conventional composites. Likewise, the CF composites of the present disclosure have higher MFI compared to conventional composites.

### Example 4: Yellowness Index Measurements

Generally, YI is associated with product degradation by light, chemical exposure, light exposure and process conditions. YI is used to quantify these types of degradation with a single value. They can be used when measuring clear liquid or solid in transmission and nearly-white, opaque solids in reflectance mode using any Hunter Lab color instrument. YI can be measured according to ASTM D1925. The ASTM D1925 uses C/2 method (illuminant C, 2-degree observer angle). Where the coefficients for Cx and Cy used are 1.28 and 1.06.

### Example 5: Cellulose Fiber Length and Width Measurements

Samples were extracted in chloromethane solvent following IP's standard procedure followed by drying of fibers. Light microscopy was done on dry extracted fiber to determine fiber length and width. Fiber measurement analysis was made using ImageJ image analysis software, as described previously. The system was calibrated using an American Optical millimeter scale. Typical dimension reported is an average of 400 individual measurements that were made on isolated fiber samples.

### Example 6: Melt Flow Index

Melt Flow Index (MFI) is a measure of ease of flow of molten thermoplastic polymer at a given temperature. It is defined as the weight of polymer in grams flowing in 10 min through a die of specific width and length by a load (pressure) applied by a given weight at a given temperature. As per ASTM test method (D1238), one typically uses a load of 2.16 kg at 230 C for PP. Due to issues with CF degradation, MFI temperature measurement was lowered to 210 C. MFI is an indirect measure of the viscosity of thermoplastic at a given shear rate. In general, a higher the MFI corresponds to a lower the viscosity of the melted plastic. MFI is a quality control method to measure the flow properties of plastics and are often used to assess batch-to-batch variations, as well as ease of filling a mold during molding.

### Example 7: Rheology Processing Index

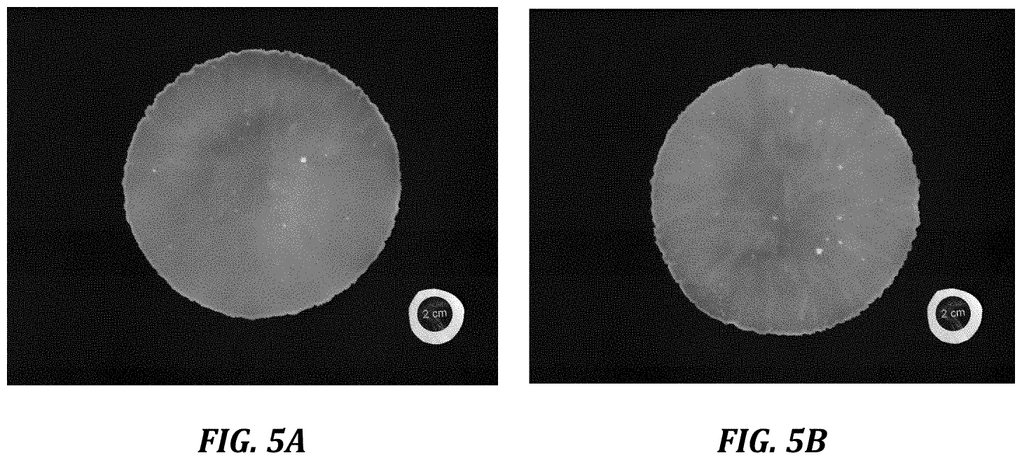

Rheology Processing Index (RPI) is a parameter that predicts the processability of a composite and is an indirect measure of ratio of low molecular weight polymer chains (important for ease of processing) and high MW chains (important for physical properties). To obtain RPI, MFI measurements are done at three different loads of 2.16 kg, 10 kg, and 21.6 kg. Three-point plot usually is a good indicator of polymer processability and molecular weight distribution (see Example FIG. 5 below). Here, we define RPI as ratio of MFI @ 21.6 kg/MFI @2.16 kg. RPI ratio can easily change if the compounding and processing parameters changes, such as, screw rpm. Higher rpms are known to cause chain scissioning PP. Hence, higher RPI value in a post-processed material compared to the pre-processed material is usually an indicator of polymer chain cessation. This in turn will affect the molding conditions and resulting composite properties. Therefore, here we propose using RPI as a quality control tool to assure lot-to-lot consistent quality of compounded pellets.

### Example 8: Physical Characteristics of Composites

Physical properties of all the samples were measured either in accordance with standard ASTM procedures, as noted in TABLE 4, or test methods developed internally referred to as IP Test method. Moisture measurement uses slightly modified version of ASTM D6980. Mettler-Toledo HR73 Halogen Moisture Analyzer was used for % moisture analysis of pellet samples. Approx. 10-12 g of pellet samples are dried at 150° C. for 12 minutes in the instrument. % weight loss of moisture is directly recorded from the instrument.

TABLE 4
Physical characteristics of CF polymer composite samples, in accordance with
an embodiment of the disclosure, and conventional CF/polymer composites.

| | ASTM Test | | | | |
|---|---|---|---|---|---|
| IP designation | method | Sample 1* | Sample 2 | Sample 3 | Sample 4 |
| % Moisture (pre and post | IP test method | <0.6% | 0.25% | 0.11% | N/A |
| drying) | | | | | |
| Density, g/cc | D6980 | 0.990 | 0.983 | 0.977 | N/A |
| Flex Mod, (secant) psi | D790 | N/A | 305000 | 304000 | N/A |
| Flex strength, (secant) psi | D790 | N/A | 9310 | 9310 | N/A |
| Flex Mod, (regression) psi | D790 | 333,000 | N/A | N/A | N/A |
| Flex strength, (regression) | D790 | 8600 | N/A | N/A | N/A |
| psi | | | | | |
| Tensile strength at break | D638 | 5100 | 5240 | 5210 | 4060 |
| Tensile strength, ultimate, | D638 | N/A | 5260 | 5210 | 4210 |
| psi | | | | | |
| Tensile modulus, psi | D638 | 432,000 | 401000 | 408000 | 327,000 |
| Percent elongation at break | D638 | 4.1 | 5.1 | 4.7 | 6.2 |
| Notched Izod, ft-lb/inch | D256 | 0.5 | 0.539 | 0.583 | |

*Typical value reported in literature for commercial grade THRIVE 20DXV235SC4N
N/A: Not available

It should be noted that for purposes of this disclosure, terminology such as “upper,” “lower,” “vertical,” “horizontal,” “inwardly,” “outwardly,” “inner,” “outer,” “front,” “rear,” etc., should be construed as descriptive and not limiting the scope of the claimed subject matter. Further, the use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings.

As used herein, the word “about” as it relates to a quantity indicates a number within range of minor variation above or below the stated reference number. For example, “about” can refer to a number within a range of 10%, 9%, 8%, 7%, 6%, 5%, 4%, 3%, 2%, or 1% above or below the indicated reference number. In some embodiments, “about” refers to a number within a range of 5% above or below the indicated reference number. In some embodiments, “about” refers to a number within a range of 10% above or below the indicated reference number. In some embodiments, “about” refers to a number within a range of 1% above or below the indicated reference number.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

While illustrative embodiments have been illustrated and described, it will be appreciated that various changes can be made therein without departing from the spirit and scope of the invention.

1. A cellulose fiber (CF) polymer composite comprising:
a polymeric matrix; and
CF distributed within the polymeric matrix,
wherein a CF agglomerate count of a 4 g pellet press-out of the CF polymer composite is less than about 25.

2. The CF polymer composite of claim 1, wherein a Yellowness index of the CF polymer composite is less than about 32.

3. The CF polymer composite of claim 1, wherein a melt flow rate of the CF polymer composite measured at 210° C. and at 21.6 kg load is in a range of about 80 g/10 minutes to about 250 g/10 minutes.

4. The CF polymer composite of claim 1, wherein a Rheology Processing Index of the CF polymer composite is in a range of about 60 to about 250.

5. The CF polymer composite of claim 1, wherein the CFs have an average CF length in a range of about 600 μm to about 1,200 μm.

6. The CF polymer composite of claim 1, wherein the CFs have an average CF width in a range of about 18 μm to about 36 μm.

7. The CF polymer composite of claim 1, wherein a flexural modulus of the CF polymer composite is in a range of about 200,000 pounds per square inch (psi) to about 400,000 psi.

8. The CF polymer composite of claim 1, wherein flexural strength of the CF polymer composite is in a range of about 7,000 psi to about 11,000 psi.

9. The CF polymer composite of claim 1, wherein a tensile strength at break of the CF polymeric matrix is in a range of about 3,000 psi to about 7,500 psi.

10. The CF polymer composite of claim 1, wherein a tensile modulus of the CF polymeric matrix is in a range of about 300,000 psi to about 550,000 psi.

11. The CF polymer composite of claim 1, wherein the polymeric matrix is a hydrophobic polymeric matrix.

12. The CF polymer composite of claim 1, wherein the polymeric matrix has a surface energy of less than about 35 dynes/cm.

13. The CF polymer composite of claim 1, wherein the polymeric matrix includes a polymer selected from the group consisting of polylactic acid, cellulose acetate, cellulose propionate, cellulose butyrate, polycarbonate, polyethylene terephthalate, high-density polyethylene, low-density polyethylene, polypropylene, polystyrene, polystyrene, polyhydroxyalkanoate, polyolefin furanoate, ethylene glycol furanoate, styrene block copolymers, polyvinyl chloride, cellulose acetate, polyvinylidene chloride, copolymers thereof, and combinations thereof.

14. The CF polymer composite of claim 1, wherein the CF polymer composite comprises CF in a range of about 5 wt % to about 35 wt %.

15. The CF polymer composite of claim 1, further comprising an additive selected from the group consisting of compatibilizing agents, coupling agents, impact modifiers, anti-oxidants, lubricants, processing aids, UV and visible light stabilizers, dispersive agents, anti-slip agents, anti-static agents, and combinations thereof.

16. The CF polymer composite of claim 15, wherein the compatibilizing agent includes a polyolefin-graft-maleic anhydride random or block copolymer or terpolymer.

17. A method of forming a CF polymer composite comprising:
introducing a master batch (MB) into a twin-screw extruder, the MB comprising a polymeric matrix and CFs coated with the polymeric matrix; and
mixing the MB in the twin-screw extruder to form the CF polymer composite;
wherein a CF agglomerate count of a 4 g pellet press-out of the CF polymer composite is less than about 25.

18. The method of claim 17, wherein a Yellowness index of the CF polymer composite is less than about 32.

19. The method of claim 17, wherein the MB includes CFs in a range of about 65 wt % to about 95 wt %.

20. The method of claim 17, wherein the polymeric matrix is a hydrophobic polymeric matrix.

21. The method of claim 17, wherein the polymeric matrix has a surface energy of less than about 35 dynes/cm.

22. The method of claim 17, wherein the polymeric matrix includes a polymer selected from the group consisting of polylactic acid, cellulose acetate, cellulose propionate, cellulose butyrate, polycarbonate, polyethylene terephthalate, high-density polyethylene, low-density polyethylene, polypropylene, polystyrene, polystyrene, polyhydroxyalkanoate, polyolefin furanoate, ethylene glycol furanoate, styrene block copolymers, polyvinyl chloride, cellulose acetate, polyvinylidene chloride, copolymers thereof, and combinations thereof.

23. The method of claim 17, wherein the polymeric matrix comprises an additive selected from the group consisting of compatibilizing agents, coupling agents, impact modifiers, anti-oxidants, lubricants, processing aids, UV and light stabilizers, dispersive agents, anti-slip agents, anti-static agents, and combinations thereof.

24. The method of claim 23, wherein the compatibilizing agent includes a polyolefin-graft-maleic anhydride random or block copolymer or terpolymer.

25. The method of claim 17, wherein mixing the MB in the twin-screw extruder includes rotating twin screws of the twin-screw extruder at a rotation frequency in a range of about 250 rotations per minute (RPM) to about 450 RPM.

26. The method of claim 17, wherein mixing the MB in the twin-screw extruder includes introducing the MB into one or more sections of the twin-screw extruder configured to mix the MB and move the mixed CF and polymeric matrix through the twin-screw extruder.

27. The method of claim 17, further comprising forming the MB by mixing the plurality of CFs and the polymeric matrix to coat the CFs within the polymeric matrix.

28. The method of claim 17, further comprising introducing a thermoplastic polymer into the twin-screw extruder; and mixing the thermoplastic polymer with the MB in the twin-screw extruder.

29. The method of claim 17, wherein the method produces the CF polymer composite at a rate in a range of about 500 lbs/hour to about 2,000 lbs/hour.
